(19) United States
(12) Patent Application Publication
(10) Pub. No.: US 2014/0081986 A1
(43) Pub. Date: Mar. 20, 2014

(54) COMPUTING DEVICE AND METHOD FOR GENERATING SEQUENCE INDEXES FOR DATA FILES

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: Chung-I LEE, New Taipei (TW); De-Yi XIE, Shenzhen (CN); Hai-Yun CHEN, Shenzhen (CN); An-Sheng LUO, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/950,645

(22) Filed: Jul. 25, 2013

(30) Foreign Application Priority Data
Sep. 18, 2012 (CN) 2012103464460

(51) Int. Cl. G06F 17/30

(52) U.S. Cl. CPC G06F 17/30091; G06F 17/30097
USPC 707/747; 707/741

(57) ABSTRACT

In a method for generating sequence indexes for data files of a computing device, index information of a data file is received from an input device of the computing device. The last index of a data index list stored in a database of a storage device is established, and an m-digits number is generated according to the storage capacity of the database. The m-digits number of the last index is calculated to obtain a sequence number, and a sequence index of the data file is generated according to the sequence number of the last index and the index information of the data file. The sequence index of the data file is inserted into the last position of the data index list, and the data index list is saved into the database of the storage device.

### BACKGROUND

1. Technical Field

Embodiments of the present disclosure relate to data index creating systems and methods, and particularly to a computing device and a method for generating sequence indexes for data files of the computing device.

2. Description of Related Art

Managing and searching through massive amounts of data files has become difficult for users. Current file systems need to be frequently searched, updated, and existing data files need to be deleted in a database of a computer system. Obviously, data indexes for the data files will greatly affect the speed of the computer system. The file systems may use the data indexes to organize the data files, and have been helpful in management of the data files. However, a key challenge is how to create data indexes for the files data in the file systems. Therefore, there is room for improvement in the art.

### BRIEF DESCRIPTION OF THE DRAWINGS

FIG. 1 is a block diagram of one embodiment of a computing device including a sequence index generating system.

FIG. 2 is a flowchart of one embodiment of a method for generating sequence indexes for data files of the computing device of FIG. 1.

FIG. 3 shows one embodiment of a data index list stored in a storage device of the computing device.

FIG. 4 shows one embodiment of inserting a sequence index of the data file into the data index list.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of a non-transitory computer-readable medium include CDs, DVDs, flash memory, and hard disk drives.

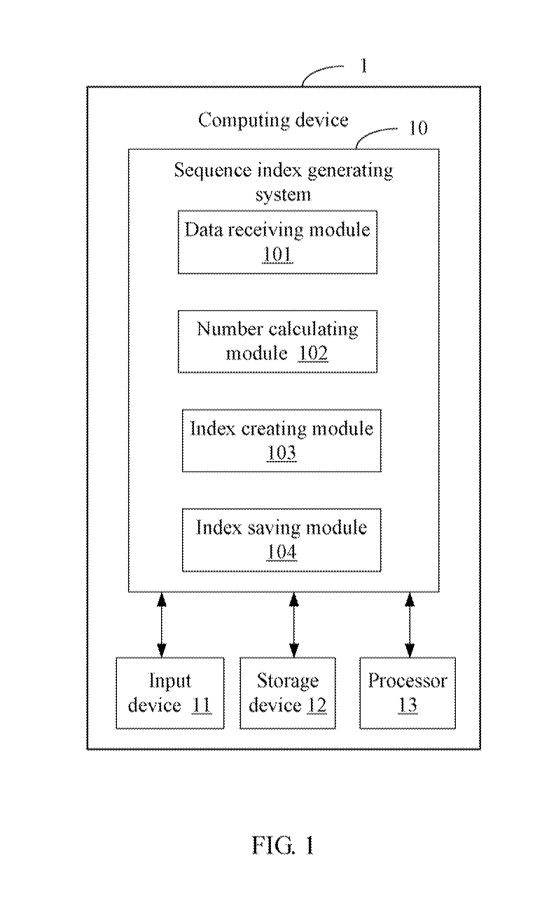

FIG. 1 is a block diagram of one embodiment of a computing device 1 including a sequence index generating system 10. In the embodiment, the sequence index generating system 10 is implemented by the computing device 1, and creates a plurality of sequence indexes for data files according to resources of the computing device 1, and inserts each of the created sequence indexes of a data file into the last position of a data index list that is stored in a database of the computer device 100. The data files may include text files, image files, and multimedia files including audio data and video data. Each of the sequence indexes is a data index of each of the data files, and indicates a sequence of each of the data files. In one embodiment, the computing device 1 may be a personal computer (PC), a server or any other data processing device.

The computing device 1 further includes, but is not limited to, an input device 11, a storage device 12 and at least one processor 13. In one embodiment, the storage device 12 may be an internal storage system, such as a random access memory (RAM) for temporary storage of information, and/or a read only memory (ROM) for permanent storage of information. The storage device 12 may also be an external storage system, such as an external hard disk, a storage card, network access storage (NAS), or a data storage medium. The at least one processor 13 is a central processing unit (CPU) or microprocessor that performs various functions of the computing device 1.

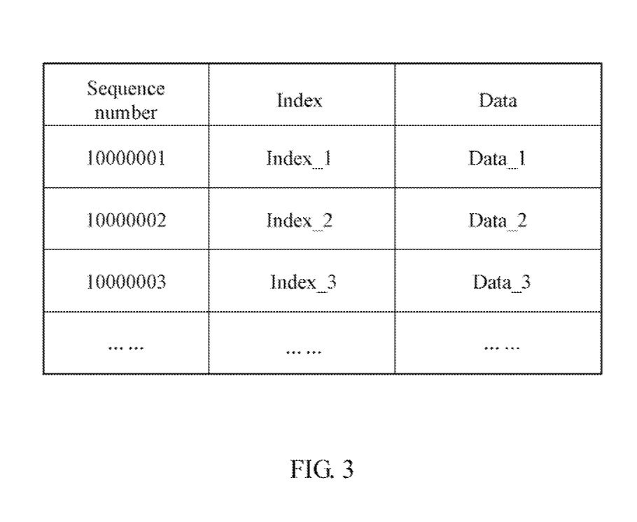

The storage device 12 includes a database that stores a data index list and a plurality of data files. FIG. 3 shows one embodiment of the data index list. The data index list stores a sequence number, a data index, and content of each of the data files. The sequence number identifies each of the data files, such as the number “10000001,” “10000002,” and “10000003.” Each of the data files corresponds to a unique data index stored in the data index list. For example, the first data index named Index_{—}1 corresponds to a data file named Data_{—}1, and the second data index named Index_{—}2 corresponds to a data file named Data_{—}2.

In one embodiment, the sequence index generating system 10 includes a data receiving module 101, a number calculating module 102, an index creating module 103, and an index saving module 104. The modules 101-104 may comprise computerized instructions in the form of one or more programs that are stored in a non-transitory computer-readable media (e.g., the storage device 12) and executed by the at least one processor 13. A description of each module is given in the following paragraphs.

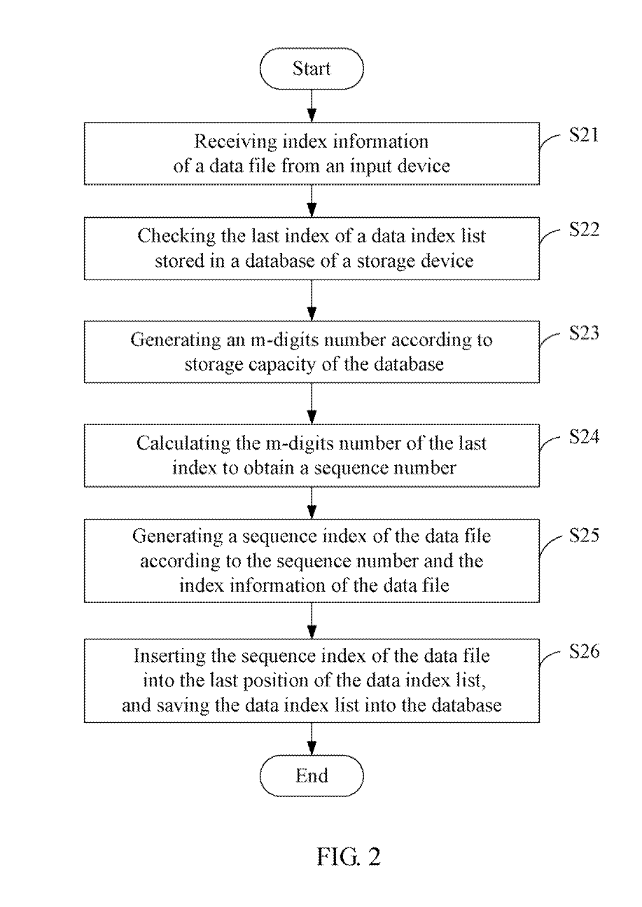

FIG. 2 is a flowchart of one embodiment of a method for generating sequence indexes for data files of the computing device 1 of FIG. 1. The method is performed by execution of computer-readable program codes or instructions by the at least one processor 13 of the computing device 1. The method generates one or more sequence indexes for data files according to resources of the computing device 1, and inserts each of the sequence indexes of a data file into the last position of the data index list stored in the storage device 12. Depending on the embodiment, additional steps may be added, others removed, and the ordering of the steps may be changed.

In step S21, the data receiving module 101 receives index information of a data file from the input device 11. The data file needs to be added into a database of the storage device 12. In the embodiment, the index information of the data file includes a data index of the data file and the content of the data file. Referring to FIG. 3, the first data index named Index_{—}1 corresponds to a data file named Data_{—}1, and the second data index named Index _{—}2 corresponds to a data file named Data_{—}2.

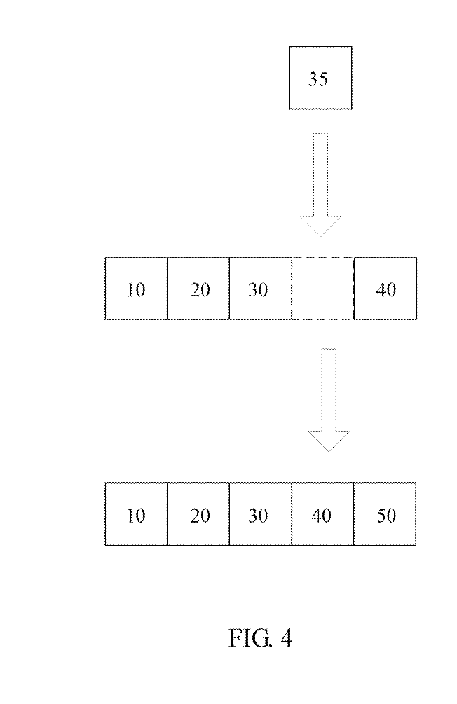

In step S22, the data receiving module 101 checks the last index of the data index list stored in the database of the storage device 12. Referring to FIG. 4, the data receiving module 101 searches the data index list of the database, and determines that the last index of the data index list is a sequence number “40.”

In step S23, the number calculating module 102 determines storage capacity of the database of the storage device 12, and generates an m-digits number according to the storage capacity of the database. In one embodiment, the m-digits number may include, but is not limited to, a quaternary number, a binary number, an octal number, a decimal number, and a hexadecimal number. For example, if the storage capacity of the database is 1632960 bytes, the number calculating module 102 generates an octal number. If the storage capacity of the database is 58786560 bytes, the number calculating module 102 generates a hexadecimal number.

In step S24, the number calculating module 102 calculates the m-digits number of the last index to obtain a sequence number. In the embodiment, the sequence number is a digital number that is calculated according to the last index and is increased in sequence, such as a decimal number “10”, a decimal number “20”, a decimal number “30”, . . . , and a decimal number “50” as shown in FIG. 4.

In step S25, the index creating module 103 generates a sequence index of the data file according to the sequence number of the last index and the index information of the data file.

In one embodiment, the index creating module 103 generates the sequence index of the data file by calculating a HASH value of the sequence number and the index information using a HASH function. The hash function is an algorithm that maps data of variable length to data of a fixed length. The values returned by a hash function are called hash values, or hash codes, or hash sums, or checksums, or simply hashes. In one example with respect to FIG. 4, if the sequence number is calculated as “35”, the sequence index of the data file may be “50” according to the index information.

In step S26, the index saving module 104 inserts the sequence index of the data file into the last position in the data index list, and saves the data index list into the database of the storage device 12. FIG. 4 shows one exemplary embodiment of inserting a sequence index of the data file into the data index list. If the sequence index of the data file is “50”, the index saving module 104 inserts the sequence index “50” into the data index list after the last position “40” of the data index list, and saves the updated data index list into the database of the storage device 12.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A computing device, comprising:
an input device, and at least one processor; and
a storage device storing one or more computer-readable program instructions, which when executed by the at least one processor, causes the at least one processor to:
receive index information of a data file from the input device;
check a last index of a data index list stored in a database of the storage device;
determine storage capacity of the database of the storage device, and generate an m-digits number according to the storage capacity of the database;
calculate the m-digits number of the last index to obtain a sequence number;
generate a sequence index of the data file according to the sequence number of the last index and the index information of the data file; and
insert the sequence index of the data file into the last position of the data index list, and save the data index list into the database of the storage device.

2. The computing device according to claim 1, wherein the sequence index of the data file is generated by calculating a HASH value of the sequence number and the index information using a HASH function.

3. The computing device according to claim 1, wherein the sequence number is a digital number that is calculated according to the last index and is increased in sequence.

4. The computing device according to claim 1, wherein the data index list stores sequence numbers, data indexes, and content of data files.

5. The computing device according to claim 4, wherein each of the sequence numbers identifies each of the data files, and each of the data files corresponds to a unique data index stored in the data index list.

6. The computing device according to claim 1, wherein the m-digits number is selected from the group consisting of a quaternary number, a binary number, an octal number, a decimal number, and a hexadecimal number.

7. A method for generating sequence indexes for data files of a computing device, the method comprising:
receiving index information of a data file from an input device of the computing device;
checking a last index of a data index list stored in a database of a storage device of the computing device;
determining storage capacity of the database of the storage device, and generating an m-digits number according to the storage capacity of the database;
calculating the m-digits number of the last index to obtain a sequence number;
generating a sequence index of the data file according to the sequence number of the last index and the index information of the data file; and
inserting the sequence index of the data file into the last position of the data index list, and saving the data index list into the database of the storage device.

8. The method according to claim 7, wherein the sequence index of the data file is generated by calculating a HASH value of the sequence number and the index information using a HASH function.

9. The method according to claim 7, wherein the sequence number is a digital number that is calculated according to the last index and is increased in sequence.

10. The method according to claim 7, wherein the data index list stores sequence numbers, data indexes, and content of the data files.

11. The method according to claim 10, wherein each of the sequence numbers identifies each of the data files, and each of the data files corresponds to a unique data index stored in the data index list.

12. The method according to claim 7, wherein the m-digits number is selected from the group consisting of a quaternary number, a binary number, an octal number, a decimal number, and a hexadecimal number.

13. A non-transitory storage medium having stored thereon instructions that, when executed by at least one processor of a computing device, cause the processor to perform a method for generating sequence indexes for data files in the computing device, the method comprising:
receiving index information of a data file from an input device of the computing device;
checking a last index of a data index list stored in a database of a storage device of the computing device;
determining storage capacity of the database of the storage device, and generating an m-digits number according to the storage capacity of the database;
calculating the m-digits number of the last index to obtain a sequence number;
generating a sequence index of the data file according to the sequence number of the last index and the index information of the data file; and
inserting the sequence index of the data file into the last position of the data index list, and saving the data index list into the database of the storage device.

14. The storage medium according to claim 13, wherein the sequence index of the data file is generated by calculating a HASH value of the sequence number and the index information using a HASH function.

15. The storage medium according to claim 13, wherein the sequence number is a digital number that is calculated according to the last index and is increased in sequence.

16. The storage medium according to claim 13, wherein the data index list stores sequence numbers, data indexes, and content of the data files.

17. The storage medium according to claim 16, wherein each of the sequence numbers identifies each of the data files, and each of the data files corresponds to a unique data index stored in the data index list.

18. The storage medium according to claim 13, wherein the m-digits number is selected from the group consisting of a quaternary number, a binary number, an octal number, a decimal number, and a hexadecimal number.
